(19) United States
(12) Patent Application Publication
(10) Pub. No.: US 2009/0063243 A1
(43) Pub. Date: Mar. 5, 2009

(54) PRIVATIZED ASSET FIRE PROTECTION

(76) Inventor: WILLIAM C. KNEEBUSCH, VALLEY CITY, OH (US)

Correspondence Address: Emerson,Thomson & Bennett, 777 West Market Street, Akron, OH, 44303, US

(21) Appl. No.: 12/017,439

(22) Filed: Jan. 22, 2008

Related U.S. Application Data
(60) Provisional application No. 60/972,938, filed on Sep. 17, 2007.
(60) Provisional application No. 60/970,069, filed on Sep. 5, 2007.

(51) Int. Cl. G06Q 10/00; G06Q 99/00; G08B 17/12

(52) U.S. Cl. 705/9; 705/1; 705/39; 340/577

(57) ABSTRACT

A method for providing external fire protection is herein disclosed, including providing a service contract for external fire protection, providing access to a dedicated firefighting unit, wherein the dedicated firefighting unit will respond to protect an associated designated piece of real estate, wherein an associated customer provides payment for the service contract, and wherein the firefighting unit responds to notification of an associated external fire at or near the piece of real estate.

### I. BACKGROUND

This application claims priority to U.S. Ser. No. 60/972,938, filed Sep. 17, 2007, entitled Self-Contained Automatic Fire Fighting System, and U.S. Ser. No. 60/970,069, filed Sep. 5, 2007, entitled Privatized Asset Fire Protection, both of which are herein incorporated by reference. This invention pertains to the arts of the prevention of fires, and more particularly to a self-contained automatic fire fighting system and privatized asset fire protection system.

### II. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of the fire fighting system;

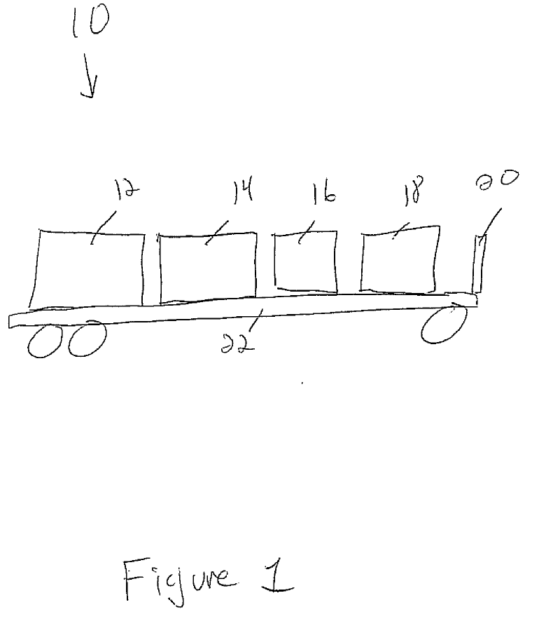

FIG. 2 is a perspective view of the pump and hoses;

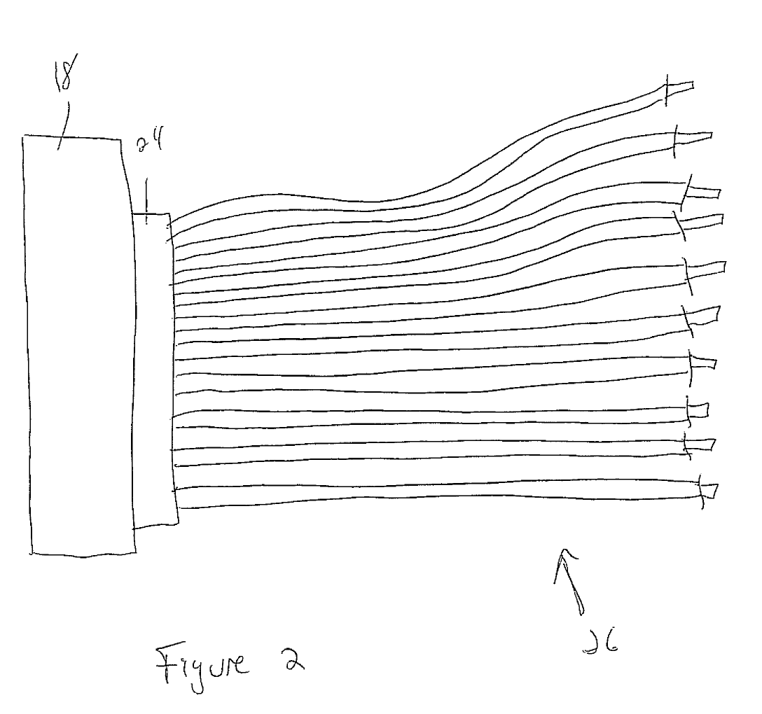

FIG. 2A is a perspective view of the sprayers;

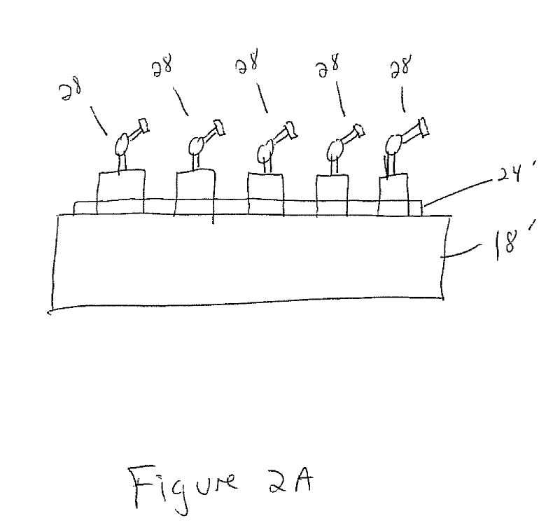

FIG. 3 is a perspective view of a house with pre-positioned sprayers;

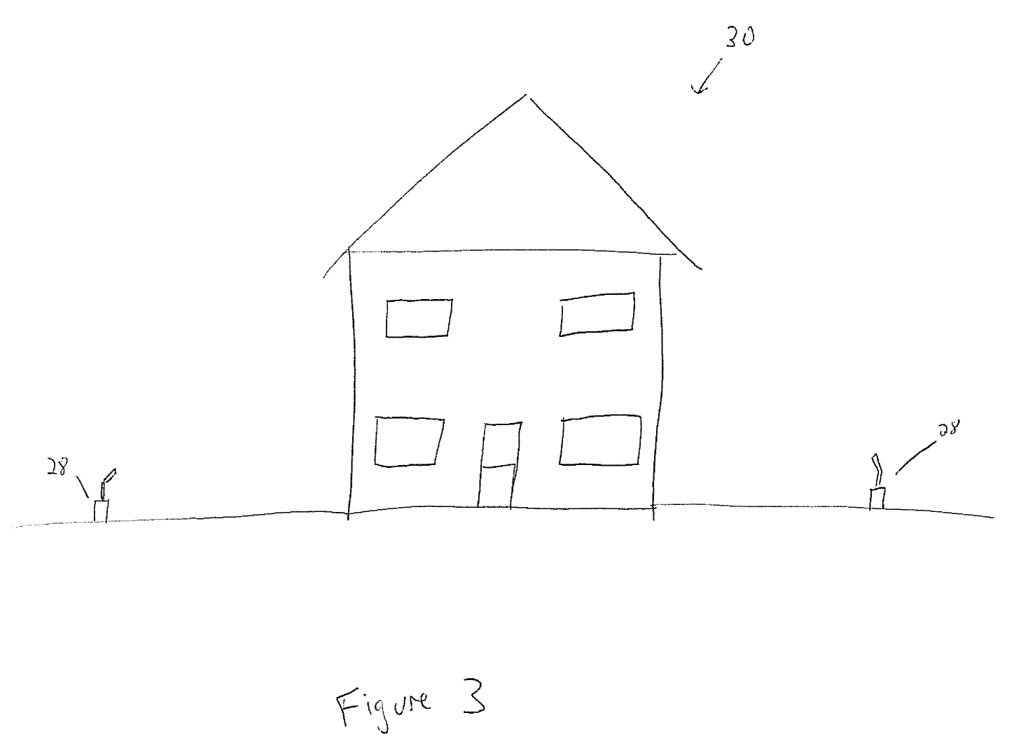

FIG. 4 is a perspective view of the sprayer;

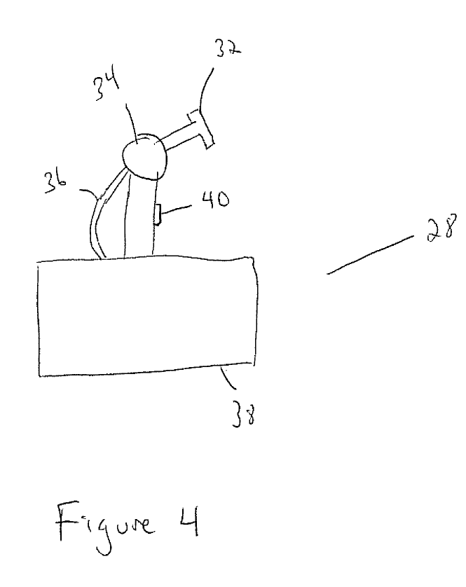

FIG. 5 is a perspective view of the sprayers spraying gel on the house; and,

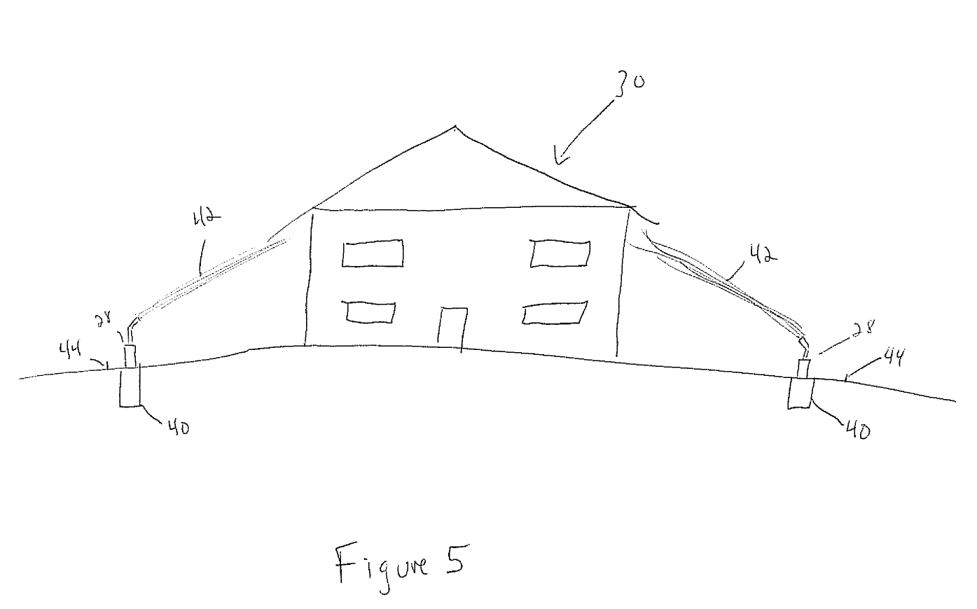

FIG. 6 is a perspective view of a road with sprayers located along the side.

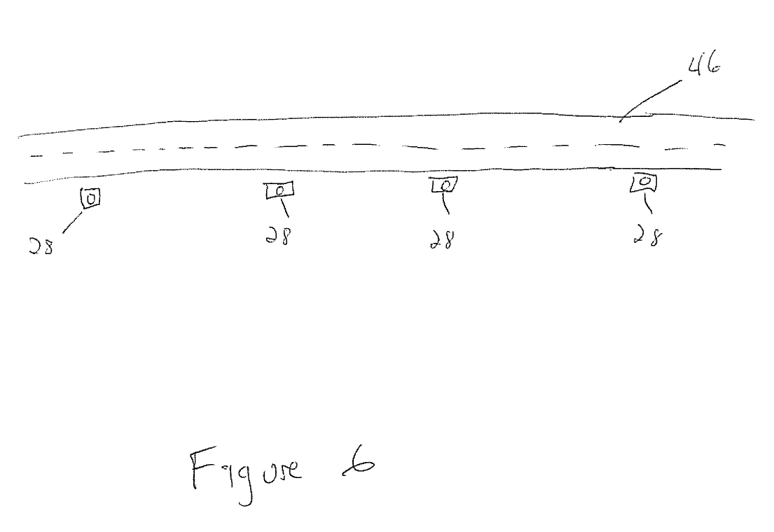

### III. DEFINITIONS

Asset—an item of value owned.

Dedicated Firefighting Unit—a firefighting unit designated for a particular customer or customers.

External Fire—the phenomenon of combustion manifested in light, flame, and heat; fuel in a state of combustion, wherein the origination point of the fire is outside a house or building.

Flame Retardant—An added substance which inhibits the initiation and/or spread of fire.

Logic Gate—performs a logical operation on one or more logic inputs and produces a single logic output.

Logic System—A circuit designed to implement or generate a logic statement or function utilizing logic gates.

Manifold—a fitting with several lateral outlets.

Private or Privatized—intended for or restricted to the use of a particular person, group, or class; belonging to or concerning an individual person, company, or interest.

Pump—a device that raises, transfers, delivers, or compresses fluids or that attenuates gases especially by suction or pressure or both.

Real Estate—All land, whether platted or unplatted. All buildings, structures or permanent improvements built upon or attached to privately-owned land. Any fixture permanently affixed to and intended to be annexed to land or permanently affixed to and intended to be a component of a building, structure, or improvement on land, including machinery and equipment which become fixtures.

Sensor—device that responds to a physical stimulus (as heat, light, sound, pressure, magnetism, or a particular motion) and transmits a resulting impulse.

Tank—a receptacle used for holding, transporting, or storing.

### IV. SUMMARY

In accordance with one embodiment, a method for providing external fire protection includes providing a service contract for external fire protection, providing access to a dedicated firefighting unit, wherein the dedicated firefighting unit will respond to protect an associated designated piece of real estate, wherein an associated customer provides payment for the service contract, and wherein the firefighting unit responds to notification of an associated external fire at or near the piece of real estate.

### V. DETAILED DESCRIPTION

In one embodiment, the method consists of creating a privatized organization equipped to handle air and/or land fixed-asset protection against external fire destruction. The main purpose of this organization is to protect a residence or other structure or real estate from destruction by fighting the external fire by utilizing a dedicated firefighting unit. In one embodiment, strict selection criteria would be used to ensure that the firefighting unit is an elite team. In this embodiment, the service contract between the owner of a piece of real estate would enter into a service contract with the service provider, and that service contract would entitle the owner to access to the dedicated firefighting unit. The firefighting unit could be made up of existing firefighters, or could be chosen from any other group. The terms of the contract are not critical to the invention, and will not be further described herein, although it is to be understood that any contract terms can be used, as long as chosen using sound business and legal judgment. In one embodiment, the contract will have specific reference to various state's constitutional right to defend one's property, which can be used to refute any ordinance preventing individuals from crossing a fire line unless they are fighting the fire for the public welfare.

In one embodiment of the invention, the owner of the real estate, who has now signed a contract with the service provider (“the customer”), would grant a power of attorney to the service provider, so that the firefighting unit could be granted a power of attorney to enter private property. Once the contract is in place, the service provider will provide access to the customer to various types of sensing devices for sensing an approaching external fire. Any type of fire-sensing device could be used, as long as it is capable of detecting external fires, and is chosen using sound engineering judgment. In this embodiment, the sensors can detect the presence of both heat and light. The sensor can detect the light from an external fire, and report to the service provider that there is an external fire near the designated real estate. The sensor can be equipped with a time delay with respect to the vision, so that a lightning strike does not set off the detector. It is to be understood that any type of sensing device can be used, as long as chosen using sound engineering judgment.

If the sensor detects an external fire within a pre-determined distance of the designated real estate, the service provider notifies the dedicated firefighting unit, and the unit is dispatched to the designated piece of real estate. It is to be understood that any pre-determined distance can be used, and any method of notifying the service provider can be used, as long as chosen using sound engineering judgment. For example, but not intending to limit the scope of the invention in any way, the sensors could send the notification via a telephone line, a radio frequency, a satellite, an Internet connection, or any other electronic communication, and the notification between the service provider and the dedicated firefighting unit could also occur in any of those ways. It is also contemplated that the sensor would send the notification directly to the dedicated firefighting unit.

Once the firefighting unit has been dispatched, the unit will go to the designated piece of real estate, and attempt to protect the designated piece of real estate from the external fire. Any type of firefighting equipment can be used by the firefighting unit, as long as chosen with sound Judgment. In one embodiment of the invention, the dedicated firefighting unit has its own fire trucks and firefighting equipment. The service contract can be structured such that a designated piece of real estate is ranked higher in importance than others, and a contract can supply more than one dedicated firefighting unit.

In another embodiment, a helicopter is deployed as an advanced countermeasure in an attempt to save the designated real estate. The service provider will sell its services on a renewable contract to customers as well as selling last minute intervention services to others. One embodiment is to establish a well-defended perimeter by air dropping (or land application of) fire retardant. This is accomplished through a coordinated effort of proper chemical mixing/application via a helicopter with a specialized bucket dispensing system. Secondly, fire resistant gels, foam, and various other products can be directly applied from the helicopter on the home to provide protection. The helicopter, or other aviation device, can be part of the dedicated firefighting unit, or could be the subject of a separate service contract. It is to be understood that the various modes of transportation for reaching the external fire, and the equipment used to fight the external fire is not intended as a limitation to this invention.

In another embodiment of this invention, the service provider will have detectors deployed around the designated piece of real estate so that the service provider can be automatically notified of an external fire. The detectors can be situated such that an external fire will set off the detectors and a signal will be sent to the service provider, which will then deploy the helicopter or other unit or equipment. It is also contemplated that each individual helicopter will be designated for specific designated real estate only and that individual customers can purchase and design their protection as they desire. Different levels of protection can be offered depending on what the customer desires.

In another embodiment, the inventive system 10 consists of a water tank 12, foam/gel/chemical tank 14, power system 16, hydraulic pump 18, heat/fire sensors 20, logic system and transportable chassis 22. The system 10 will typically be constructed from a tandem axle trailer (not shown), for mobility purposes, with all components built upon the sub-frame. The system 10 will be equipped with numerous water hoses 26 (in one embodiment, up to ten). A single pump 18 or multiple pumps will feed the hoses 26 through a manifold 24. The primary purpose of this device is to aid in home protection during wild fires. In most cases, the home owner will be evacuated from their home well before the fire arrives. This system 10 will “stand guard,” and upon the first detection of heat/fire by the sensors 20, the system 10 will begin to deploy a flame retardant foam/gel product 42 through the multiple hoses 26, which would have been pre-positioned before the system 10 was triggered. The pre-positioning is determined based on the location of the home/property 30 and the surrounding terrain, as well as the most likely starting place for a fire.

It is to be understood that the number of hoses 26, pumps 18, tanks 12, 14, power systems 16, and sensors 20 are not intended as limitations of this invention. Any number of the preceding could be used with this invention, as long as chosen using sound engineering judgment. It is also to be understood that the various components can be operatively connected to each other in various ways and embodiments. This is a needed system, because most usable retardants typically have a 4-6 hour effective life. Therefore, the retardant is being applied to the home/building at the most effective time.

At least one embodiment has been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

1. A method for providing external fire protection, the method comprising the steps of:
providing a service contract for external fire protection;
providing access to a dedicated firefighting unit, wherein the dedicated firefighting unit will respond to protect an associated designated piece of real estate;
wherein an associated customer provides payment for the service contract; and,
wherein the firefighting unit responds to notification of an associated external fire at or near the piece of real estate.

2. The method of claim 1, wherein the method further comprises the steps of:
providing at least one external fire sensor; and,
providing communication between the sensor and the dedicated firefighting unit.

3. The method of claim 2, wherein the dedicated firefighting unit owns or controls at least one fire truck.

4. The method of claim 3, wherein the dedicated firefighting unit provides all necessary firefighting equipment.

5. The method of claim 1, wherein the method further comprises:
the dedicated firefighting unit attempting to fight the associated external fire.

6. The method of claim 4, wherein the method further comprises:
providing an associated power of attorney to the dedicated firefighting unit,
wherein the power of attorney grants access to the designated piece of real estate.

7. A method for providing external fire protection, the method comprising the steps of:
providing at least one automated sprayer;
providing at least one sensor;
sensing an external fire;
activating the at least one automated sprayer; and,
spraying an associated designated piece of real estate with a fire retardant compound.

8. The method of claim 7, wherein the automated sprayer is located underground when not in use.

9. The method of claim 8, wherein the automated sprayer raises from the ground upon being activated.

10. The method of claim 9, wherein the sensor has time delay to prevent premature activation.

11. A method for providing external fire protection, the method comprising the steps of:
receiving a communication regarding an associated external fire in an associated designated area;
providing an associated response team; and,
the associated response team setting up at least one sprayer near the associated designated area.

12. The method of claim 11, wherein the sprayer sprays a flame retardant compound.

13. The method of claim 12, wherein the sprayer can be activated remotely.

14. A method for providing external fire protection, the method comprising the steps of:
providing a service contract regarding an associated designated piece of real estate;
providing an external fire monitoring device to monitor for external fires;
receiving a communication regarding an associated external fire in the associated designated area;
providing an associated response team, wherein the response team comprises:
a chassis;
at least one hose; and,
at least one fire retardant compound; and,
providing firefighting assistance to the designated piece of real estate.

15. The method of claim 14, wherein the response team comprise trained firefighters.

16. The method of claim 15, wherein the compound is a gel.

17. The method of claim 7, wherein the compound is a gel.

18. The method of claim 12, wherein the compound is a gel.

19. An external fire protection system, wherein the system comprises:
at least one automated sprayer, wherein the sprayer has a motor, a nozzle, a fluid container, and a pump;
at least one sensor, the sensor being operatively connected to the sprayer;
at least one relay between the sensor and the sprayer, wherein the sprayer can be activated; and,
a monitoring system, wherein the monitoring system will monitor an associated designated piece of real estate.

20. The system of claim 19, wherein the sprayer contains fire retardant gel.
